(19) United States
(12) Patent Application Publication
(10) Pub. No.: US 2019/0003417 A1
(43) Pub. Date: Jan. 3, 2019

(54) MULTIPLE VALVE CYLINDER HEAD

(71) Applicant: Edelbrock, LLC, Torrance, CA (US)

(72) Inventor: Matthew Gamble, Torrance, CA (US)

(73) Assignee: Edelbrock, LLC, Torrance, CA (US)

(21) Appl. No.: 16/111,135

(22) Filed: Aug. 23, 2018

Related U.S. Application Data
(63) Continuation of application No. PCT/US18/40814, filed on Jul. 3, 2018.
(60) Provisional application No. 62/528,286, filed on Jul. 3, 2017.

(51) Int. Cl. F02F 1/42; F02F 1/24; F02B 75/22

(52) U.S. Cl. CPC F02F 1/4285; F02B 2075/1832; F02B 75/22; F02F 1/242

(57) ABSTRACT

A cylinder head comprising a single intake valve and at least two exhaust valves per cylinder. The two or more exhaust valves may provide additional curtain area and total cross sectional area for the exhaust flow and better performance for engines equipped with a cylinder head in accordance with the present disclosure.

### PRIORITY

This application is a continuation of International Application No. PCT/US18/40814, filed Jul. 3, 2018, which claims priority to U.S. Application No. 62/528,286, filed Jul. 3, 2017, each of which is incorporated by reference in its entirety into this application.

### BACKGROUND

Reference may be made herein to other United States Patents, foreign patents, and/or other technical references. Any reference made herein to other documents is an express incorporation by reference of the document so named in its entirety.

Engines, particularly internal combustion engines, have undergone incremental advances in the past few decades. The introduction of fuel injection to replace carburetors, advances in engine design and materials, and other design changes have increased the fuel efficiency and/or output power of current engine designs.

### SUMMARY

The present disclosure describes an internal combustion engine with multiple valves for a given cylinder in the internal combustion engine.

A cylinder head in accordance with an aspect of the present disclosure may comprise a single intake valve and at least two exhaust valves per cylinder. The two or more exhaust valves may provide additional curtain area and may provide a larger combined equivalent overall exhaust valve area for the exhaust flow and better performance for engines equipped with a cylinder head in accordance with the present disclosure.

The above summary has outlined, rather broadly, some features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same or similar purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further features and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates a cutaway perspective view of an internal combustion engine in accordance with an aspect of the present disclosure.

FIG. 2 illustrates a side view of an overhead valve internal combustion engine in accordance with an aspect of the present disclosure.

FIG. 3 illustrates a top (overhead) view of a cylinder head in accordance with an aspect of the present disclosure.

FIG. 4 illustrates a bottom (crankshaft) view of a cylinder head in accordance with an aspect of the present disclosure.

FIG. 5 illustrates a bottom (crankshaft) view of a cylinder in a cylinder head in accordance with an aspect of the present disclosure.

FIGS. 6-11 illustrate various views and cross sectional cutaways of an exemplary cylinder head according to embodiments described herein in use with an internal combustion engine.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

Many different designs have been used in internal combustion engines to increase output power (e.g., horsepower), efficiency, torque, and other engine performance characteristics. One such design approach is to use multiple valves in an OHV engine design.

A multi-valve (also “multivalve”) internal combustion engine is an engine where each cylinder has more than two valves (i.e., one intake valve and one exhaust valve). A multi-valve engine may have a greater capability to intake air and fuel and/or expel exhaust from each cylinder than an engine that has only two valves. Multi-valve engines may also be able to operate at higher revolutions per minute (RPM) than a two valve engine, which may provide more power and/or torque from the multi-valve engine as compared to a two-valve engine.

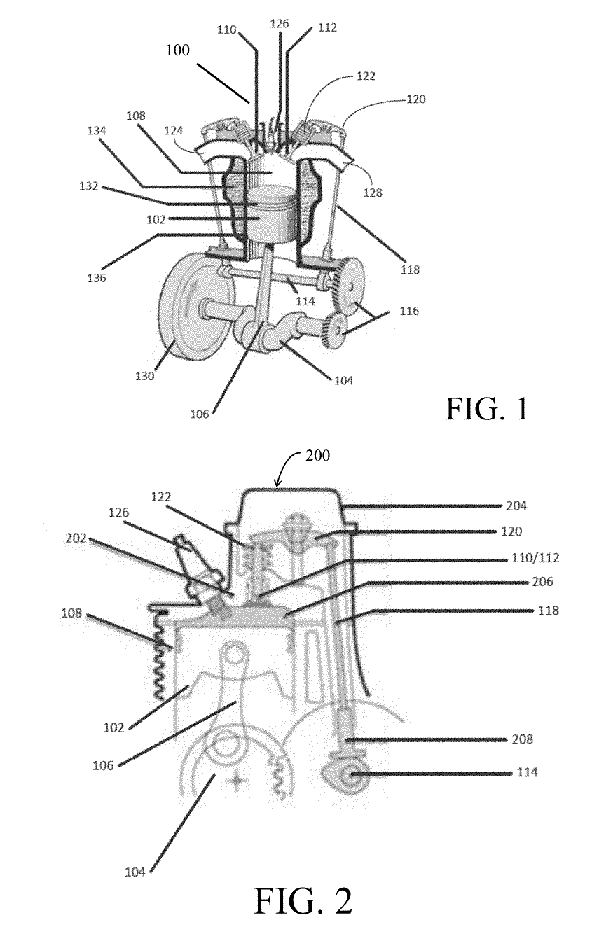

FIG. 1 illustrates a cutaway perspective view of an internal combustion engine in accordance with an aspect of the present disclosure.

Engine 100 comprises piston 102 connected to crankshaft 104 via connecting rod 106. Piston 102 moves up and down in cylinder 108. Intake valve 110 and exhaust valve 112 opens and close based on the movement of camshaft 114, which is coupled to crankshaft 104 by timing gears 116. As camshaft 114 rotates, pushrods 118 lift rocker arms 120, which compresses spring 122 to open intake valve 110 and/or exhaust valve 112.

When intake valve 110 is open, a mixture of air and fuel is drawn into the cylinder 108 via intake 124. As piston 102 moves toward spark plug 126, intake valve 110 closes and closes off cylinder 108 compressing the mixture of air and fuel. When spark plug 126 fires, the air/fuel mixture ignites and pushes piston 102 away from spark plug 126. As crankshaft 104 rotates such that piston 102 again moves toward spark plug 126, exhaust valve 112 opens to allow the exhaust gases to escape from cylinder 108 through exhaust 128, and intake valve 110 again opens to provide a new air/fuel mixture for combustion in cylinder 108. The intake/compression/combustion/exhaust cycle for engine 100 repeats, as flywheel 130 aids in maintaining the rotation of crankshaft 104. Rings 132 maintain a desired pressure inside cylinder 108, and coolant 134 within coolant enclosure 136 aids in removing heat from cylinder 108. Depending on the number of strokes used to complete the combustion cycle, and the number of cylinders in engine 100, variations on the above description of engine 100 operation are possible within the scope of the present disclosure. Exemplary embodiments described herein may also be used with an air cooled engines, such as with motorcycles, and therefore does not require coolant enclosure 136. Exemplary embodiments described herein may also be used with compression ignition engines, such as with Diesels, wherein Spark Plug 126 would be replaced with a fuel injector.

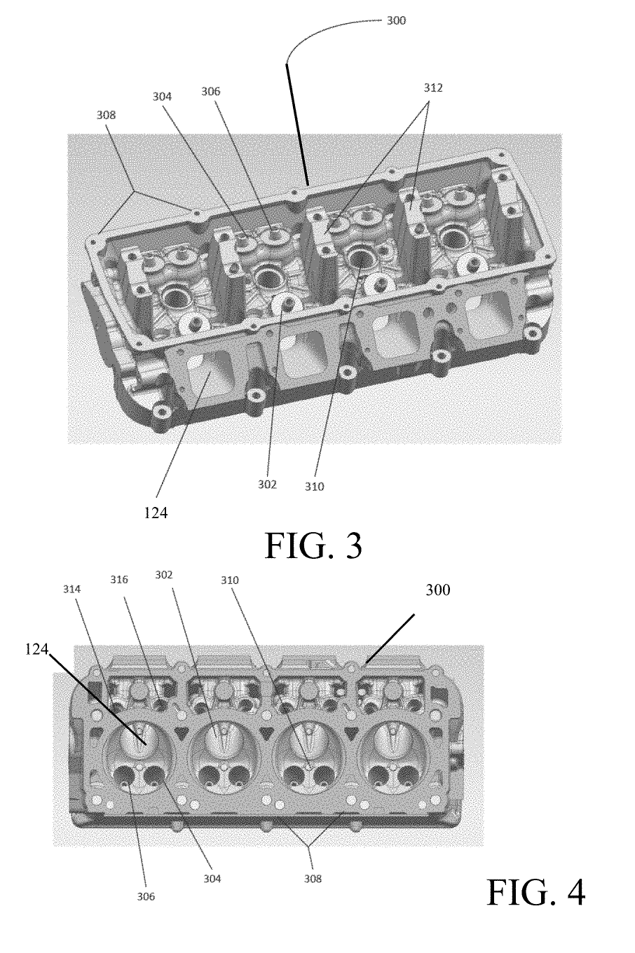

FIG. 2 illustrates a side view of an overhead valve internal combustion engine in accordance with an aspect of the present disclosure.

Engine 200 is similar to that of engine 100, and the side view of FIG. 2 illustrates the engine head 202, a head cover 204, the combustion chamber 206 within cylinder 108, and valve lifter 208 that is in contact with camshaft 114. As shown in FIG. 2, the valve 110/112 closes off the combustion chamber 206 when piston 102 is near the top of the piston 102 travel within cylinder 108 (also known as the “stroke” of the piston 102). The valves 110/112 are above (“over”) the cylinder head 202 as viewed in FIG. 2, and thus, the engine 200 design is often called an overhead valve (OHV) engine design.

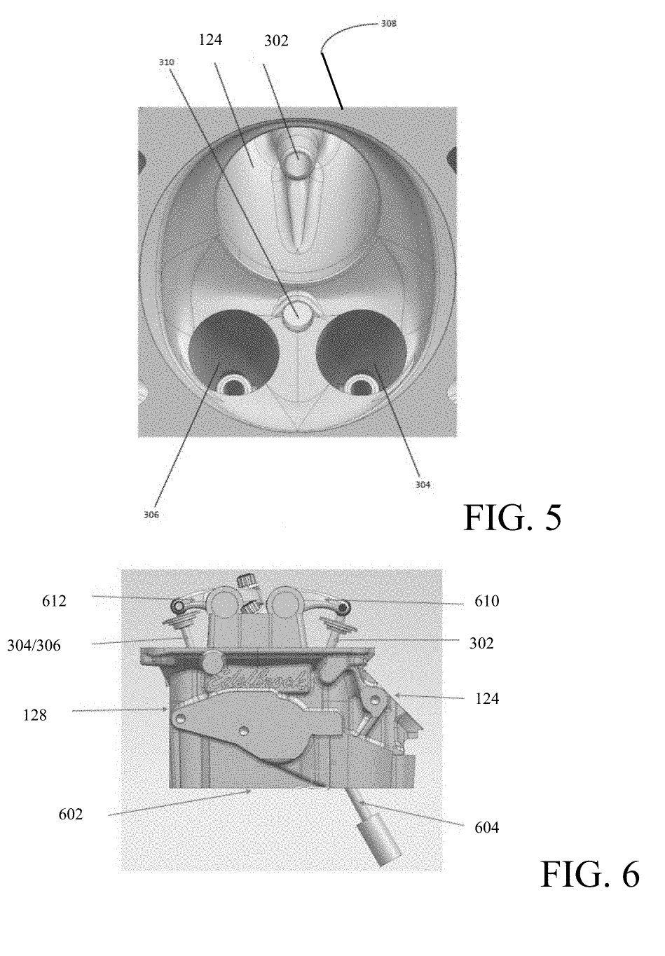

FIG. 3 illustrates a top (overhead) view of a cylinder head in accordance with an aspect of the present disclosure.

Cylinder head 300, in an aspect of the present disclosure, comprises an intake valve (not shown), which is similar to intake valve 110, and two exhaust valves (not shown), which are similar to exhaust valve 112, for each cylinder 308 in cylinder head 300. Intake 124 is illustrated, but intake valve and exhaust valves are not shown for clarity. As shown in FIG. 3, cylinder head 300 has four cylinders 308; however, a larger or smaller number of cylinders 308 within a cylinder head 300 are possible without departing from the scope of the present disclosure. Further, multiple cylinder heads 300 may be employed in a single engine, e.g., two four-cylinder cylinder heads 300 may be used in an eight-cylinder engine, two three-cylinder cylinder heads 300 may be used in a six-cylinder engine, etc., without departing from the scope of the present disclosure.

Cylinder head 300 also comprises spark plug access 310, which places a spark plug 126 (not shown in FIG. 3 for clarity) at or near the center of each cylinder 308 in cylinder head 300. Placing spark plug access 310 at or near the center of each cylinder 308 may provide more efficient combustion of the air/fuel mixture provided through intake 124, as the spark plug 126 ignition will be more uniformly distributed about each cylinder 308 in such a configuration. Although shown in the center of each cylinder 308, spark plug access 310 may be placed elsewhere without departing from the scope of the present disclosure.

Rocker arm attachment 312 provides attachments points on cylinder head 300 for rocker arms 120 (not shown in FIG. 3 for clarity), allowing for an OHV design for cylinder head 300 if desired. Although shown as a pushrod design, cylinder head 300 may also be used in an OHC engine design without departing from the scope of the present disclosure.

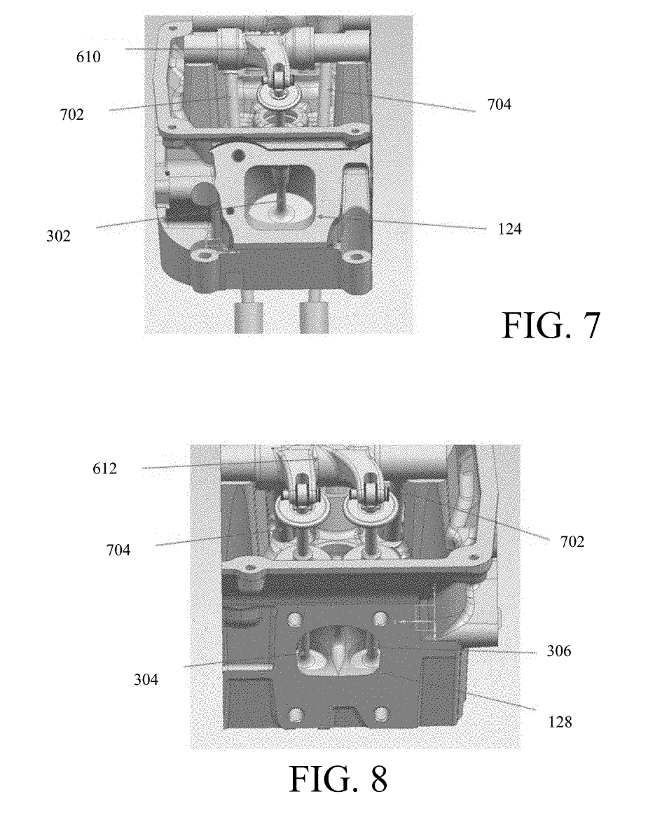

FIG. 4 illustrates a bottom (crankshaft) view of a cylinder head in accordance with an aspect of the present disclosure.

As shown in FIG. 4, each cylinder 308 in cylinder head 300 has spark plug access approximately centrally located in cylinder 308. Further, intake valve 302 (associated with intake valve guide shown) and exhaust valves 304 and 306 (associated with exhaust valve guides shown) are not shown for clarity, but the associated guides are shown. Pushrod access holes 314 and 316 are shown on either side of Intake 124. In an aspect of the present disclosure, cylinder head 300 provides an efficient design because pushrod holes 314 and 316 minimally intrude with intake port 124 cross sectional area (CSA) providing minimal impact on the ports ability to flow air or air/fluid mixture of each cylinder 308, and the single intake valve 302 comprises a larger area of cylinder 308, which may provide more efficient distribution of the air/fuel mixture into cylinder 308.

The two exhaust valves 304 and 306 of cylinder head 300, in an aspect of the present disclosure, also allow for a total valve area that may be larger than with a single exhaust valve 112 arrangement when coupled with Intake valve 302. Further, the arrangement of a single intake valve 302 and two exhaust valves 304 and 306, by offsetting the center of the intake valve 302 with respect to the centers of exhaust valves 304 and 306, may reduce and/or eliminate contact between intake valve 302 and exhaust valves 304 and 306. This contact may be referred to as “valve clipping,” which may reduce the seal efficiency between the valves and the valve seats on the cylinder head 300 and may offer other performance benefits as it relates to camshaft design.

Because the valves 302, 304, and 306 are opening and closing during the engine cycles, the cross sectional area which the air/fuel mixture and/or exhaust flow passes through changes. This flow area is referred to as the “effective area” of the valve 302, 304, and/or 306. This area is defined as:

Aₑ=A_{c}(q)C_{d}(q)

Where: A_{c}=curtain area and C_{d}=discharge coefficient.
The curtain area, A_{c}, is given by:

Aₑ=πDᵥ Lᵥ

Where: Dᵥ=diameter of the valve and Lᵥ=lift away from the valve seat.

The curtain area for the dual exhaust valves 304 and 306 is much larger than a single exhaust valve 112. To achieve the same curtain area for a single exhaust valve 112, the diameter and/or lift of the single exhaust valve 112 would be too large for a given cylinder 308 diameter, and likely require different timing to lift the single exhaust valve 112 a further distance. Such changes to the engine design would likely result in imbalanced engine rotation, valve clipping, and/or other undesirable issues.

Further, because the curtain area is larger for the two exhaust valves 304 and 306, the flow through the two exhaust valves 304 and 306 is greater at a given lift for the exhaust valves 304 and 306. This allows for less backpressure in the cylinder 308 and greater efficiency at removal of the exhaust from the cylinder 308. The exhaust port 128 from the two exhaust valves 304 and 306 can be a single exhaust port coupled to both exhaust valves 304 and 306, or can be an individual exhaust port 128 for each of the two exhaust valves 304 and 306 without departing from the scope of the present disclosure.

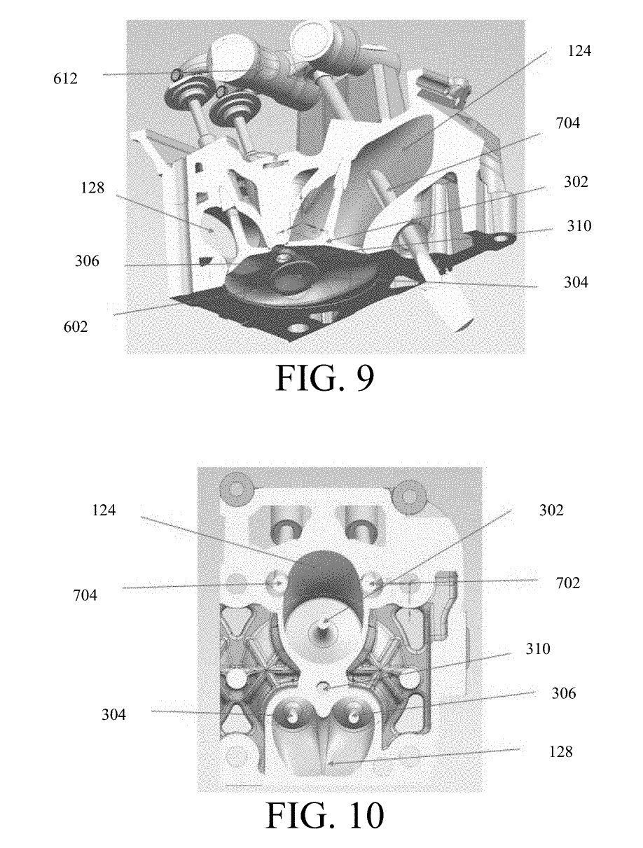

FIG. 5 illustrates a bottom (crankshaft) view of a cylinder in a cylinder head in accordance with an aspect of the present disclosure.

As seen in FIG. 5, the distance between the intake valve 302 (not shown in FIG. 3 for clarity) and the exhaust valves 304 and 306 (not shown in FIG. 5 for clarity) is sufficient to allow for spark plug access 310 in the approximate center of cylinder 308. Further, because the exhaust valves 304 and 306 are smaller in diameter, the lift required for the exhaust valves to achieve a certain curtain area can be reduced, which may reduce vibrations and/or other engine design requirements. As such, the flow through the exhaust valves 304 and 306 may be greater than a single exhaust valve 112 at low lift values.

The diameter of the exhaust valves 304 and 306 are shown as approximately equivalent; however, the diameters of each of the exhaust valves 304 and 306 may be different values without departing from the scope of the present disclosure.

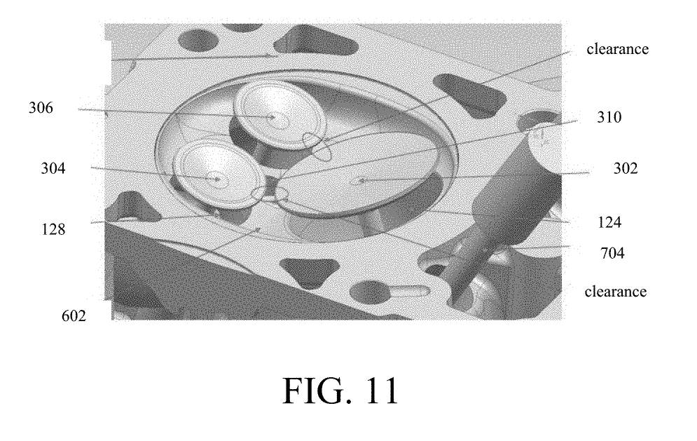

FIGS. 6-11 illustrate an exemplary cylinder head according to embodiments described herein in use with an internal combustion engine.

Exemplary embodiments of the cylinder head according to embodiments described herein may be used in an internal combustion engine. For example, exemplary embodiments may be used in an engine comprising a push rod and cam shaft. Exemplary embodiments may be used for engine configurations in which the push rod and cam shaft are on the same side of the engine. Exemplary embodiments may be used in which the push rod and cam shaft are on an inlet side of an engine. Exemplary embodiments may be used with a V engine comprised of any number of cylinders. Exemplary embodiments may be used with an inline cylinder engine. Exemplary embodiments may be used in an internal combustion engine regardless of orientation as in-line or vee or in the number of cylinders.

FIG. 6 illustrates an exemplary side profile of an embodiment described herein. As shown, the engine may include inlet valve 110 and exhaust valve 112 having an inlet port 124 and exhaust port 128. Inlet valve 302 may be coupled to inlet rocker arm 610 and exhaust valves 304 and 306 coupled to outlet rocker arm 612. The rocker arms 610, 612 may be supported by rocker arm attachments 312 of cylinder head 300. As illustrated in FIG. 6, the lower part of the engine is cut away to reveal the combustion chamber 602 and push rod 604.

FIGS. 7-11 illustrate various cross sectional cut away views of exemplary embodiments of an engine.

FIG. 7 illustrates an exemplary cut away from an inlet side of the engine. As shown, exemplary embodiments include a single valve 110 on the intake port 124. The single valve permits larger area such that the cross sectional area of the valve may be greater than the cross sectional area of either one of the exhaust valves. As shown, the push rods (push rod for the inlet 702 and push rod for the exhaust 704 are on the same side as the inlet port 124. As shown, the single inlet valve may provide an intake port with minimal pushrod intrusion.

FIG. 8 illustrates an exemplary cut away from an outlet side of the engine. The push rods (inlet push rod 702 and exhaust push rod 704) can be seen in the background behind exhaust valves 304 and 306. Exemplary embodiments include a dual valve exhaust portion with a single opening. The exhaust rocker arm 612 may be forked so that two extensions couple one to each of the valves 304 and 306. As shown, the engine may include a single exhaust port 128. However, embodiments are not so limited and each exhaust valve 304 and 306 may have its own dedicated exhaust port separated from the other exhaust valve. As seen by a comparison of FIGS. 7-8, the exhaust valves may define an approximately equal or larger overall cross sectional area compared to the single inlet valve, while the individual exhaust valve may have a smaller cross sectional area than the inlet valve. In an exemplary embodiment, the combined cross sectional area of the exhaust valves is approximately equal to or smaller than the cross sectional area of the inlet valve.

FIGS. 9-10 illustrate alternative cross sectional views to better illustrate the component layout and relative sizes of the component parts described herein. For example, FIG. 10 illustrates cross sectional view of the engine through the top of the cylinder head such that the valves can be seen more clearly. The relative dimensional size can therefore be better understood. The positioning of the inlet valve and inlet port relative to the push rods can also be appreciated. From this view, it can be appreciated that the single inlet valve permits a greater inlet area given the presence of the pushrods on the inlet side of the engine. Exemplary embodiments may therefore be used to create a larger valve area and port and not restrict or interfere with the push rod configuration. The single inlet therefore provides an alternative to a packaging restriction imposed by the pushrods both being on the inlet side of the engine. FIG. 9 illustrates an exemplary cross sectional view of the engine through one of the exhaust valves and the inlet valve to illustrate the approximately relative size of the inlet and exhaust ports while having a larger inlet valve and two smaller exhaust valves. The positioning of the intake portion to the pushrod can also be seen in FIG. 9.

FIG. 11 illustrates an exemplary internal view of the cylinder head. As seen in this illustration, the clipping clearance can be appreciated. By incorporating two exhaust valves, additional space may be provided to enlarge the inlet valve and still maintain sufficient volume to exhaust the engine gases after initiation. The intake and exhaust valves are illustrated as open approximately 0.4 inches and maintain a clipping clearance so that the valves do not contact during use. As can be appreciated, exemplary embodiments of the single inlet valve and dual exhaust valves permit the inlet valve to be designed as large as possible while accommodating the push rods and cam shaft on the inlet side. The dual exhaust valves permit the additional size of the inlet valve and reduce the potential interference or clipping during use and provide sufficient exhaust volume on the side of the engine not restricted by other engine components.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device.

Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The description of the disclosure is provided to enable any person skilled in the art to make or use the disclosure. Various modifications to the disclosure will be readily apparent to those reasonably skilled in the art, and the generic principles defined herein may be applied to other variations without departing from the spirit or scope of the disclosure. Thus, the present disclosure is not intended to be limited to the examples and designs described herein but is to be accorded the widest scope consistent with the principles and novel features disclosed herein. Accordingly, the disclosure is not to be limited by the examples presented herein, but is envisioned as encompassing the scope described in the appended claims and the full range of equivalents of the appended claims.

What is claimed is:

1. A cylinder head, comprising:
at least one cylinder, in which the at least one cylinder comprises:
a single intake valve having an intake diameter;
a first exhaust valve having a first diameter; and
a second exhaust valve having a second diameter, in which the first diameter and the second diameter are each less than the intake diameter.

2. The cylinder head of claim 1, in which the at least one cylinder further comprises an access point, between the intake valve, the first exhaust valve and the second exhaust valve.

3. The cylinder head of claim 2, wherein the access point provides access to the cylinder for a spark plug or fuel injector.

4. The cylinder head of claim 3, wherein the first diameter is equal to the second diameter.

5. The cylinder head of claim 3, wherein the single intake valve is the one and only one intake valve for one of the at least one cylinders.

6. An internal combustion engine, comprising:
a cylinder head, having at least one cylinder, in which the at least one cylinder includes:
a single intake valve having an intake diameter,
a first exhaust valve having a first diameter, and
a second exhaust valve having a second diameter, in which the first diameter and the second diameter are each less than the intake diameter.

7. The internal combustion engine of claim 6, in which the at least one cylinder further comprises an access point, between the intake valve, the first exhaust valve and the second exhaust valve.

8. The internal combustion engine of claim 7, wherein the access point provides access to the cylinder for a spark plug or fuel injector.

9. The internal combustion engine of claim 8, wherein the first diameter is equal to the second diameter.

10. The internal combustion engine of claim 9, wherein the single intake valve is the one and only one intake valve for one of the at least one cylinders.

11. The internal combustion engine of claim 10, wherein the first exhaust valve and the second exhaust valve are fluidly coupled to a single exhaust port.

12. The internal combustion engine of claim 11, further comprising an exhaust push rod and an inlet push rod on a same side of the engine as the intake valve.

13. The internal combustion engine of claim 12, wherein the cylinder head has at least eight cylinders, and each of the cylinders includes:
a single intake valve having an intake diameter,
a first exhaust valve having a first diameter, and
a second exhaust valve having a second diameter, in which the first diameter and the second diameter are each less than the intake diameter.

14. The internal combustion engine of claim 13, wherein the cylinders are in a V configuration.

15. The internal combustion engine of claim 14, further comprising a spark plug or fuel injector positioned centrally between the inlet valve and the first exhaust valve and the second exhaust valve.
